(19) United States
(12) Patent Application Publication
(10) Pub. No.: US 2005/0088282 A1
(43) Pub. Date: Apr. 28, 2005

(54) Device and process for identification of keys

(76) Inventor: Lutrell Denson, Philadelphia, PA (US)

Correspondence Address: Licata & Tyrrell P.C., 66 East Main Street, Marlton, NJ, 08053, US

(21) Appl. No.: 10/947,841

(22) Filed: Sep. 23, 2004

Related U.S. Application Data
(60) Provisional application No. 60/506,000, filed on Sep. 24, 2003.

(51) Int. Cl. H04B 1/00

(52) U.S. Cl. 340/5.73; 340/5.6

(57) ABSTRACT

A key identifying device and processes for use of this device to measure key cut and key length of a key and store this key signature along with information corresponding to the key identity in a permanent memory unit of the device for future recall are provided.

This patent application claims the benefit of priority to U.S. Provisional Patent Application Ser. No. 60/506,000, filed Sep. 24, 2003, the teachings of which are herein incorporated by reference in their entirety.

### FIELD OF THE INVENTION

The present invention relates to a device that reads the unique characteristics of a key and stores that information along with the key identity in its internal memory for future recall. Once a key's data has been entered into the database of the device the key can be uniquely identified upon reentering of the key into the device. Processes for identifying a key using the device are also provided.

### BACKGROUND OF THE INVENTION

Various keys and accessory devices for identification thereof are known.

U.S. Pat. No. 6,175,385 describes a digital key identification system capable of using a scanner to capture a cross-sectional image that is stored in a computer database.

U.S. Pat. No. 4,899,391 discloses an automated key identification and matching system using a video camera to digitize the key images and a computer memory for storage.

U.S. Pat. No. 6,064,747 discloses a means for identification of keys using a light beam.

### SUMMARY OF THE INVENTION

An object of the present invention is to provide a key identifier device which comprises a key insertion slot, a key reader inside the key insertion slot capable of measuring key length and key cut, a temporary memory unit for temporary storage of a key signature formed from the measured key length and key cut during comparison to saved key signatures and corresponding key identity information in permanent memory storage, a permanent memory unit for storage of saved key signatures and corresponding key identity information, a display unit showing key identity information for an inserted key having a saved key signature, a key pad unit for entry and saving of key identity information for a new key signature into the permanent memory unit, and a power supply for the key identifier device.

Another object of the present invention is to provide a process for identifying a key which comprises inserting a key into the key insertion slot of a key identifier device of the present invention, measuring the key length and key cut of the inserted key to determine the key signature; and comparing the key signature to saved key signatures in a permanent memory storage unit of the key identifier device wherein matching of the inserted key to a saved key signature will be indicated by display of the key identity on the display unit of the key identifier device. When the key signature of the inserted key does not match with any saved key signatures in the permanent memory unit of the key identifier device, this process may further comprise entry of key identity information corresponding to the inserted key into the key identifier device via the key pad unit of the device and saving of the key signature and corresponding key identity information for the inserted key in the permanent memory unit of the key identifier device.

### BRIEF DESCRIPTION OF THE DRAWINGS

FIG. 1 depicts an embodiment of the key identifier device of the present invention showing the identifier with a key inserted in the key insertion slot and the identity of the key displayed on the display unit. Also shown in this outside view of an embodiment of the key identifier device is the key pad.

FIG. 2 depicts an exemplary configuration of the internal functional units of the key identifier device of the present invention.

FIG. 3 provides a flow chart outlining the steps involved in a process of identifying a key and/or storing a new key signature using the key identifier device of the present invention.

### DETAILED DESCRIPTION OF THE INVENTION

The present invention provides a device referred to herein as the Key Identifier, which reads and stores the unique characteristics and user input name or identity of any key in its internal memory. Upon reentering the key into the device, the Key Identifier displays the identity of the key on its LCD display. Processes for use of this device in the identification of keys are also provided. The “Key Identifier” comprises a key insertion slot 2 sized to fit most keys including, but not limited to, single- and double-sided keys. Such as, car keys, door keys, desk keys, etc. and the following functional units or blocks; a key reading unit 3, a temporary memory unit 4, a permanent memory unit 5, a display unit 6, a power supply unit 7, and a key pad unit 8, in an integrated circuit board design. All the functional units and their associated components and circuitry are preferably contained on one circuit board.

The key reading unit 3 of the Key Identifier of the present invention reads any key that is inserted into a key insertion slot 2 on the side of the Key Identifier. The key reading unit 3 comprises a plurality of micro-switches that are pressure sensitive and temporary memory. By inserting a key into the key insertion slot of the Key Identifier, the Key Identifier is placed in the “on” condition. Information regarding the key length and the key cut measured by the micro-switches is used to form the unique key signature. The key signature is a digital word that is stored in memory and used at a later time to identify the key.

Once a key has been read by the key reading device, the key signature is sent to the temporary memory unit 4. The key signature is maintained in temporary memory where it is compared against key signature digital words stored in the permanent memory unit 5.

If a match is found between the key signature in the temporary memory and a key signature in the permanent memory, then a “Go” signal is sent from the temporary memory unit 4 to the permanent memory unit 5. The “Go” signal tells permanent memory to send the user input name and/or identity of the inserted key to the display unit 6. The data is preferably displayed as long as the key remains in the Key Identifier. When the key is removed the device automatically turns to the “off” condition.

If there are no matches between the key signature digital word in temporary memory and key signatures saved in permanent memory, then a “No Go” signal is sent from the temporary memory unit 4 to the permanent memory unit 5. When a “No Go” signal is received from the temporary memory unit 4, the permanent memory unit 5 checks for available memory. If there is no more available memory then the message “Memory Full” is sent to the display unit. If available memory is found, the permanent memory unit sends the message “Enter Key ID” to the display unit 6. The user then enters the key identity using the key pad unit 8. A set memory signal is also sent from the key pad unit 8 to the permanent memory unit 5 so that the permanent memory unit 5 retrieves the key signature digital word from temporary memory and stores both pieces of data in associated memory in the permanent memory unit 5. If the user decides not to save the key identity information, then all the user has to do is remove the key from the device prior to entry of the key identity via the key pad unit and all temporary memory will be erased and the “Key Identifier” will automatically turn off.

The display unit 6 of the device preferably comprises an LCD display unit capable of displaying at least 10 characters at a time. The display unit 6 receives messages from the permanent memory unit for display. As will be understood by those of skill in the art upon reading this disclosure, other types of display units equivalent to an LCD display unit can also be used.

The device is powered by a power supply unit 7, the main function of which is to supply operating voltages to the “Key Identifier”. Various power sources can be used. A convenient power source for use because of its small size is a typical watch battery. However, as will be understood by those skilled in the art, other power sources can be used.

The key pad unit 8 functions as the primary user input device. The user is be able to enter the key identity into the Key Identifier's memory via the key pad unit. The key pad unit thus comprises input keys that allow for editing and deletion of key identities. The key pad unit also preferably has an input key for turning on the back lighting for low light conditions while that input key is depressed.

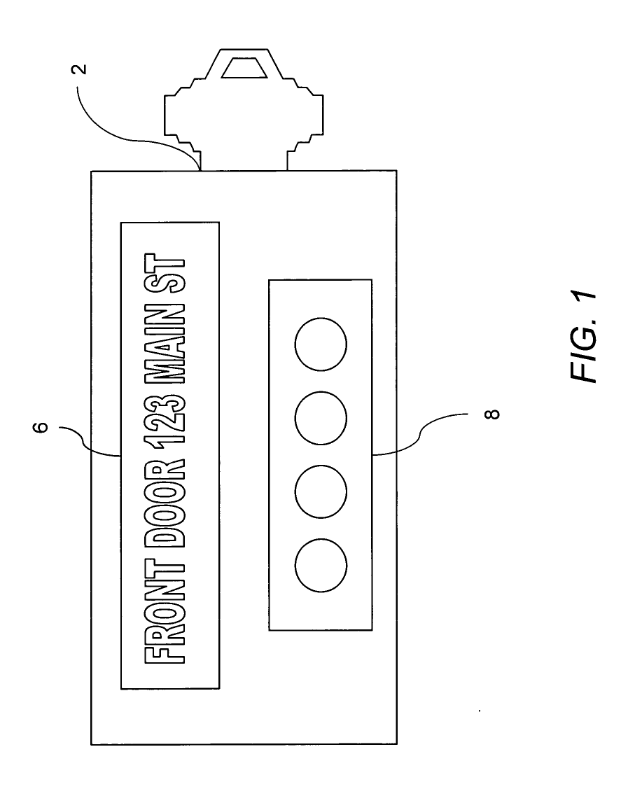

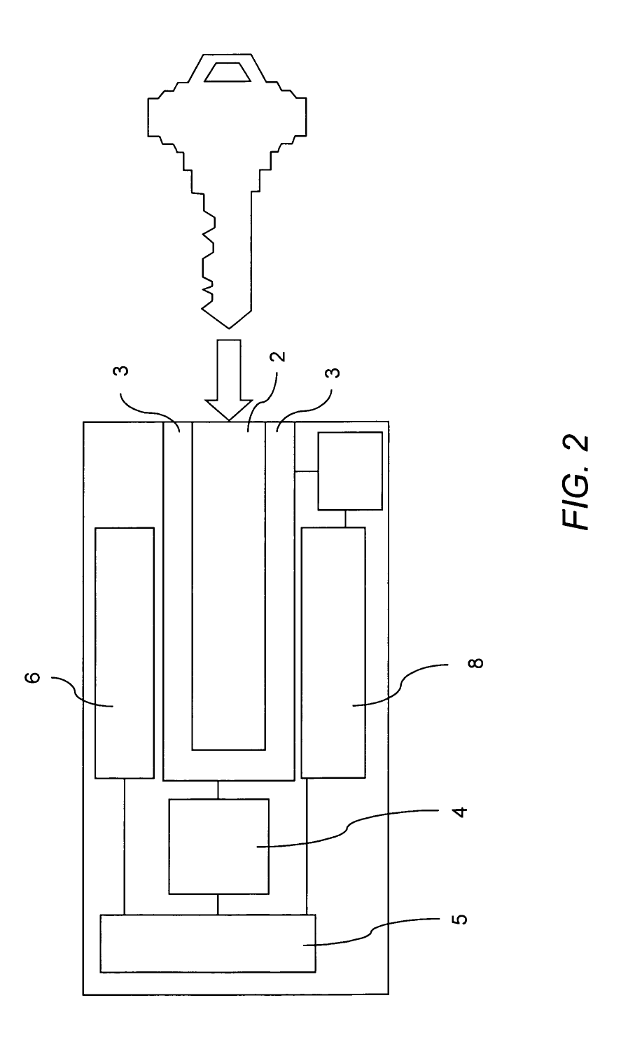

As will be understood by the skilled artisan upon reading this disclosure, various configurations of the functional units described herein can be used in the key identifier device. An exemplary embodiment of a key identifier device showing a key inserted into the key identifier slot, the display unit with the identification of the key and a key pad is shown in FIG. 1. FIG. 2 provides an exemplary embodiment of one configuration of the internal functional units of this invention.

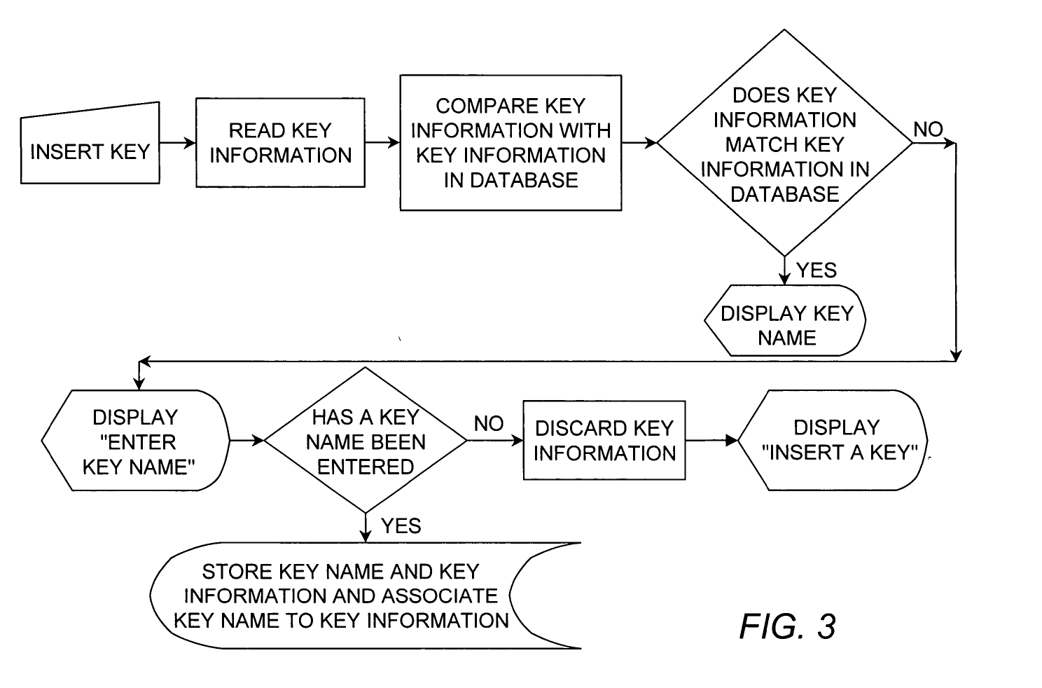

The present invention also relates to a process for identifying a key with this device. See FIG. 3. In this process, a key is first inserted into the device and the key length and key cut of the inserted key is measured to determine the key signature. The key signature of the inserted key is then compared to key signature saved in the permanent memory unit of the key identifier device. If the inserted key matches a saved key signature, the key identity is displayed on the display unit of the key identifier device (see FIG. 1). If the key signature of the inserted key does not match with any saved key signatures in the permanent memory unit of the key identifier device, if memory is available, a user will be prompted by the display to enter key identity information. If key identity information is entered the key identifier will save the key identity information and the new key signature in the permanent storage information. If the user does not wish to save the key signature, the key can be removed from the key identifier and the key signature will be erased from the temporary memory unit.

The Key Identifier of the present invention thus eliminates the frustration and confusion caused by having numerous keys on a key ring and not knowing what doors or locks the keys unlock. This invention is thus particularly useful for real estate agents, property and building managers, security personnel and everyday consumers that have several keys on key rings or in desk drawers and can not remember what those keys go to.

1. A key identifier device comprising:
(a) a key insertion slot;
(b) a key reader inside the key insertion slot capable of measuring key length and key cut;
(c) a temporary memory unit for temporary storage of a key signature formed from the measured key length and key cut;
(d) a permanent memory unit for storage of saved key signatures and corresponding key identity information;
(e) a display unit which displays key identity information for an inserted key having a saved key signature or prompts a user to insert key identity information for a new key signature;
(f) a key pad unit for entry and saving of key identity information for a new key signature into the permanent memory unit; and
(g) a power supply.

2. A process for identifying a key comprising:
(a) inserting a key into the key insertion slot of the key identifier device of claim 1;
(b) measuring key length and key cut of the inserted key to determine the key signature; and
(c) comparing the key signature of the inserted key to saved key signatures in the permanent memory unit of the key identifier device,
wherein matching of the inserted key to a saved key signature will be indicated by display of the key identity on the display unit of the key identifier device.

3. The process of claim 2 wherein, when the key signature of the inserted key does not match any saved key signature, the process further comprises:
(d) entering key identity information corresponding to the inserted key into the key identifier device via the key pad unit of the device; and
(e) saving the key signature and corresponding key identity information for the inserted key in the permanent memory unit of the key identifier device.
